(19) United States
(12) Patent Application Publication
(10) Pub. No.: US 2025/0052777 A1
(43) Pub. Date: Feb. 13, 2025

(54) AUTOMATED SYSTEM FOR FLUID TRANSFER IN CLEARING AND IMMUNOSTAINING OF LARGE SAMPLES

(71) Applicant: Translucence Biosystems, Inc., Irvine, CA (US)

(72) Inventors: Ricardo R. Azevedo, Irvine, CA (US); Jack Zeitoun, Irvine, CA (US); Anthony Reksoatmodjo, Irvine, CA (US)

(21) Appl. No.: 18/927,006

(22) Filed: Oct. 25, 2024

Related U.S. Application Data
(63) Continuation-in-part of application No. 17/213,951, filed on Mar. 26, 2021.
(60) Provisional application No. 63/000,865, filed on Mar. 27, 2020.

(51) Int. Cl. G01N 35/10; G01N 1/31

(52) U.S. Cl. CPC G01N 35/1009; G01N 1/31

(57) ABSTRACT

A solution transfer system for tissue sample incubation. The system includes cartridges, each including a sample chamber and openings disposed on its surface. The sample chamber may hold a tissue sample. The system further includes a flow plate assembly having a main channel, and a main inlet, and a main outlet fluidly coupled to it. The flow plate assembly further includes hollow bodies, each one configured to contain a cartridge. Each hollow body further includes an inlet interface fluidly coupled to the first opening and the main channel and an outlet interface fluidly coupled to the second opening and the main channel. Each hollow body further includes valves at the inlet and outlet interfaces. The system further includes a control mechanism operatively coupled to the valves, configured to actuate each valve individually.

### CROSS-REFERENCES TO RELATED APPLICATIONS

This application is a continuation-in-part and claims benefit of U.S. Non-Provisional application Ser. No. 17/213,951, filed Mar. 26, 2021, which is a non-provisional and claims benefit of U.S. Provisional Application No. 63/000,865, filed Mar. 27, 2020, the specifications of which are incorporated herein in their entirety by reference.

### STATEMENT REGARDING FEDERALLY SPONSORED RESEARCH OR DEVELOPMENT

This invention was made with government support under Grant No. R43 MH125549 awarded by National Institutes of Health. The government has certain rights in the invention.

### FIELD OF THE INVENTION

The present invention is directed to the clearing and immunostaining of biological samples through the use of incubation fluids. Specifically, the present invention is directed to the automation of transferring incubation fluids in a tissue-clearing and immunostaining system.

### BACKGROUND OF THE INVENTION

Tissue clearing enables deep imaging of complex tissues such as whole mouse brains by rendering the tissue optically transparent. Modern tissue-clearing strategies require precise control over small-volume fluid exchange and often use hazardous reagents. Currently, no automated systems exist that sufficiently allow for the fluid exchange required by tissue clearing strategies, such as iDISCO+; and none provide the chemically inert properties required to handle caustic chemicals used by processes such as iDISCO+. The present disclosure provides a new system that allows for the fully automated exchange of solutions used in large-scale tissue processing and clearing. Our system will reduce sample processing time, improve reproducibility, and eliminate unnecessary man-hours.

### BRIEF SUMMARY OF THE INVENTION

It is an objective of the present invention to provide automated fluid transfer systems for tissue sample incubation that allow for automated and efficient incubation of a tissue sample, as specified in the independent claims. Embodiments of the invention are given in the dependent claims. Embodiments of the present invention, and portions thereof, can be freely combined with each other if they are not mutually exclusive.

The present invention features a solution transfer system for tissue sample incubation. The system may comprise one or more cartridges, each comprising a sample chamber, and a first opening and a second opening disposed on the surface of the sample chamber. The sample chamber may hold a tissue sample. The system may further comprise a flow plate assembly comprising a main channel, and a main inlet and a main outlet fluidly coupled to the main channel. The flow plate assembly may further comprise one or more hollow bodies, each hollow body configured to removably contain a cartridge. Each hollow body may comprise an inlet interface fluidly coupled to the first opening and the main channel. Each hollow body may further comprise an outlet interface fluidly coupled to the second opening and the main channel. Each hollow body may further comprise an inlet valve fluidly coupled to the inlet interface and an outlet valve fluidly coupled to the outlet interface. The flow plate assembly may further comprise a main valve disposed in the main channel. The system may further comprise a control mechanism operatively coupled to the valves, configured to actuate each valve individually.

The present invention features an automated fluid transfer system for tissue sample incubation, comprising a cartridge and a cartridge holder. The cartridge may comprise a sample chamber that may hold a tissue sample and a first and second opening for allowing fluid to travel in and out of the sample chamber. The cartridge holder may comprise a hollow body, an inlet port and an outlet port fluidly connected to the hollow body and covered by a first closure mechanism, a drainage port fluidly connected to the hollow body and covered by a second closure mechanism, and a sensor disposed within the hollow body. Inserting the cartridge into the cartridge holder triggers the sensor, actuating the first closure mechanism to allow a fluid from the inlet port to enter the sample chamber through the first opening and to allow air from within the sample chamber to escape through the first opening and through the outlet port. The tissue sample sits in the fluid until it has been sufficiently incubated, and at this point, the second closure mechanism is actuated to allow the fluid to exit the sample chamber through the second opening and through the drainage port and air to enter through the outlet port.

The cartridge holder may further comprise an expansion or swivel means acting as a clamp to lock the cartridge in place. The cartridge holder may further comprise a first and second deflector for protecting the tissue sample from disruption as a result of liquid flow. A closure mechanism for an opening may be a sliding mechanism with an angled tip to reduce friction. In different configurations, each of the three ports may be paired to any of the two openings.

Any feature or combination of features described herein are included within the scope of the present invention, provided that the features included in any such combination are not incompatible or mutually inconsistent, as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIGS. 1A-1E show a method of the automated fluid transfer system of the present invention.

FIGS. 2A-2B show an embodiment of a closure mechanism of the present invention.

FIGS. 3A-3E show a method of the automated fluid transfer system of the present invention comprising a first and a second deflector.

FIGS. 4A-4B show alternative embodiments of the cartridge of the present invention.

FIG. 4C shows an alternative embodiment of the cartridge holder of the present invention.

FIGS. 5A-5E show an alternative embodiment of a system of the present invention.

FIGS. 6A and 6B show an alternative embodiment of a cartridge of the present invention.

FIGS. 6C and 6D show an alternative embodiment of a system of the present invention.

FIG. 7A shows a top-down view of the flow plate assembly of the present invention.

FIG. 7B shows the path of solution/air when the first chamber of the assembly is targeted.

FIG. 7C shows the path of solution/air when the second chamber of the assembly is targeted.

FIG. 7D shows the path of solution/air when flushing the assembly to clear any residual solution from the main channel.

FIG. 8A shows a chamber of the present invention in the drain phase.

FIG. 8B shows a chamber of the present invention in the fill phase.

FIG. 9A shows a diagram of the fluid transfer system of the present invention comprising one hollow chamber and cartridge, a control mechanism for the valves, and a rotation assembly.

FIG. 9B shows a diagram of the fluid transfer system of the present invention comprising multiple hollow chambers and cartridges, a control mechanism for the valves, and a rotation assembly.

FIG. 9C shows a flow chart of a method for controlled fluid transfer of the present invention.

### DETAILED DESCRIPTION OF THE INVENTION

Following is a list of elements corresponding to a particular element referred to herein:
10 cartridge
12 sample chamber
14 first opening
16 second opening
18 tissue sample
20 cartridge holder
22 hollow body
24 inlet port
26 surface
28 outlet port
30 drainage port
32 sensor
34 inner surface
36 first closure mechanism
38 second closure mechanism
40 expansion means
42 solution
110 sample chamber
112 outer surface
122 hollow body
134 inner surface
138 closure subassembly
148 sliding mechanism
150 gap
210 cartridge
212 sample chamber
214 first opening
216 second opening
218 tissue sample
220 cartridge holder
222 hollow body
224 inlet port
226 surface
228 outlet port
230 drainage port
236 first closure mechanism
238 second closure mechanism
242 solution
252 first deflector
254 second deflector
302 tissue chamber
304 tissue chamber
310 chamber body
312 inlet valve
314 outlet valve
316 5 ml sample chamber
318 20 ml sample chamber
402 fluid exchange station
410 mounting posts
412 bottom clamp
414 top clamp
416 servo motor
418 limit switch
420 registration pins
422 base mount
510 cartridge
512 sample chamber
514 first opening
516 second opening
518 tissue sample
520 cartridge holder
522 hollow body
524 air port
526 surface
528 solution inlet port
530 solution drainage port
532 sensor
534 inner surface
536 first closure mechanism
538 second closure mechanism
610A cartridge
610B cartridge
612A cartridge wall
612B cartridge wall
614A opening
614b opening
700 clearing system
710 cartridges
720 cartridge holders
760 automated clearing station
764 blanks
766 hinges
770 base
772 rotatable sub-assembly
780 movable lid
782 inlets
784 outlets
790 pump assembly
792 solution inlet
794 solution outlet
800 flow plate assembly
802 main inlet
804 main outlet
810 main channel
820 first chamber
822 first inlet interface
824 first outlet interface
826 first inlet valve
828 first outlet valve
830 second chamber
832 second inlet interface
834 second outlet interface
836 inlet valve
838 outlet valve
840 main valve
850 control mechanism
860 rotating assembly
900 chamber
902 chamber inlet
904 chamber outlet
910 existing solution
1000 system

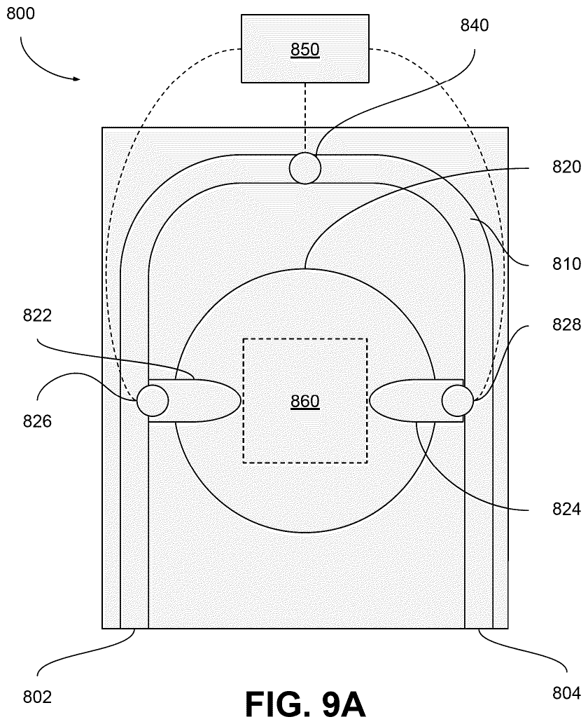

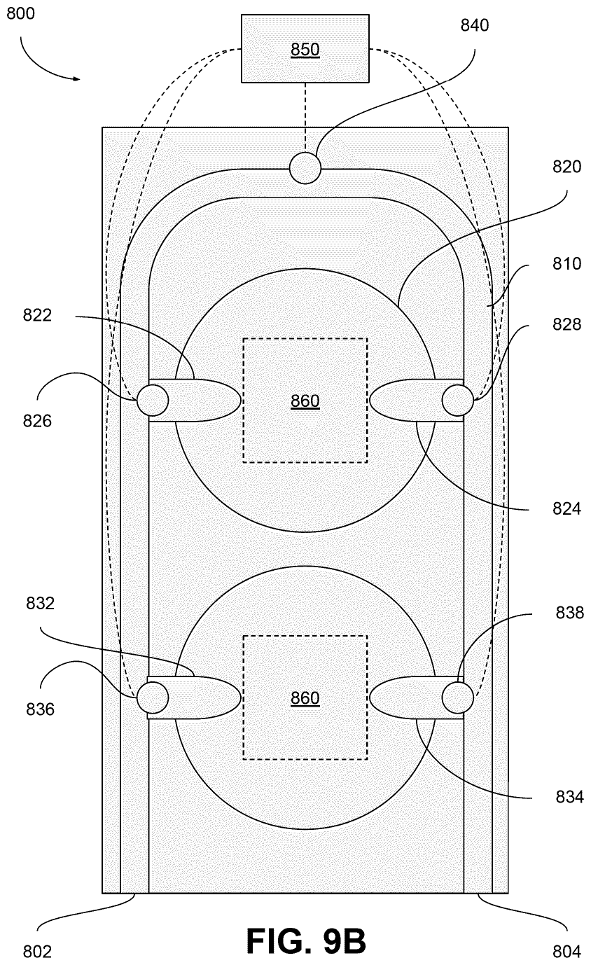

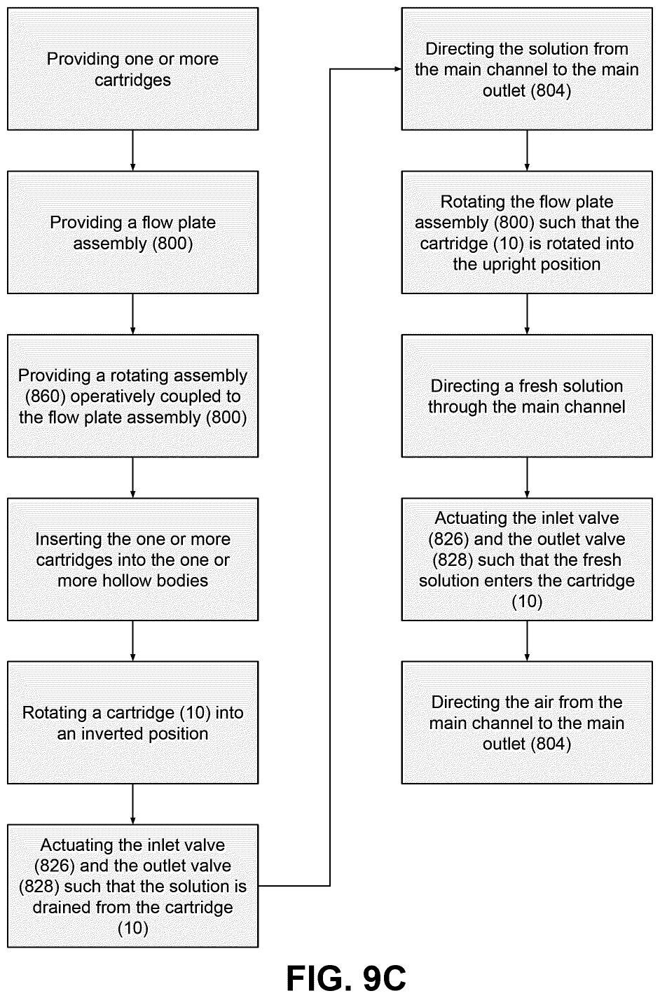

Referring now to FIGS. 9A-9B, the present invention features a solution transfer system 1000 for tissue sample incubation. In some embodiments, the system 1000 may comprise one or more cartridges. Each cartridge 10 may comprise a sample chamber 12. Each cartridge 10 may further comprise a first opening 14 disposed on a surface of the sample chamber 12. Each cartridge 10 may further comprise a second opening 16 disposed on the surface of the sample chamber 12. The sample chamber 12 may hold a tissue sample. The system 1000 may further comprise a flow plate assembly 800. The flow plate assembly 800 may comprise a main channel 810. The flow plate assembly 800 may further comprise a main inlet 802 fluidly coupled to the main channel 810. The flow plate assembly 800 may further comprise a main outlet 804 fluidly coupled to the main channel 810.

The flow plate assembly 800 may further comprise one or more hollow bodies, each hollow body 820 configured to removably contain a cartridge 10 of the one or more cartridges. Each hollow body 820 may comprise an inlet interface 822 fluidly coupled to the first opening 14 of the cartridge 10 and the main channel 810. Each hollow body 820 may further comprise an outlet interface 824 fluidly coupled to the second opening 16 of the cartridge 10 and the main channel 810. Each hollow body 820 may further comprise an inlet valve 826 fluidly coupled to the inlet interface 822. Each hollow body 820 may further comprise an outlet valve 828 fluidly coupled to the outlet interface. The flow plate assembly 800 may further comprise a main valve 840 disposed in the main channel 810 downstream of the one or more inlet interfaces of the one or more hollow bodies and upstream of the one or more outlet interfaces of the one or more hollow bodies. The system 1000 may further comprise a control mechanism 850 operatively coupled to the one or more inlet valves of the one or more hollow bodies, the one or more outlet valves of the one or more hollow bodies, and the main valve 840, configured to actuate each valve individually.

In some embodiments, the one or more inlet valves, the one or more outlet valves, the main valve 840, or a combination thereof may comprise solenoid valves. In some embodiments, the system 1000 may further comprise a rotating assembly 860 operatively coupled to the flow plate assembly 800, configured to rotate the one or more hollow bodies from an upright position to an inverted position and to rotate the one or more hollow bodies from the inverted position to the upright position. In some embodiments, each cartridge 10 of the one or more cartridges may be configured to contain a solution.

The present invention features a method for flushing a cartridge 10 of the one or more cartridges of the system 1000. The method may comprise rotating the flow plate assembly 800 such that the cartridge 10 is rotated into the inverted position. The method may further comprise actuating the inlet valve 826 and the outlet valve 828 of the hollow body 820 containing the cartridge 10 such that the solution is drained from the cartridge 10 through the second opening 16 into the main channel 810, and air enters the cartridge 10 through the first port. The method may further comprise directing the solution from the main channel 810 to the main outlet 804.

The present invention features a method for filling a cartridge 10 of the one or more cartridges of the system 1000. The method may comprise rotating the flow plate assembly 800 such that the cartridge 10 is rotated into the upright position. The method may further comprise directing the solution through the main channel 810. The method may further comprise actuating the inlet valve 826 and the outlet valve 828 of the hollow body 820 containing the cartridge 10 such that the solution enters the cartridge 10 through the first opening 14, and air exits the cartridge 10 through the second opening 16. The method may further comprise directing the air from the main channel 810 to the main outlet 804.

In some embodiments, the system 1000 may further comprise a first deflector disposed within the sample chamber 12 relative to the first opening 14. The system 1000 may further comprise a second deflector disposed within the sample chamber 12 relative to the second opening 16. In some embodiments, the first deflector may protect the tissue sample from disruption as a result of the solution entering the sample chamber 12 through the first opening 14. In some embodiments, the second deflector may protect the tissue sample from disruption as a result of the solution exiting the sample chamber 12 through the second opening 16. In some embodiments, at least one of the first and second deflectors may comprise a corrosion-resistant panel.

The present invention features a solution transfer system 1000 for tissue sample incubation. In some embodiments, the system 1000 may comprise one or more cartridges. Each cartridge 10 may comprise a sample chamber 12. Each cartridge 10 may further comprise a first opening 14 disposed on a surface of the sample chamber 12. Each cartridge 10 may further comprise a second opening 16 disposed on the surface of the sample chamber 12. The sample chamber 12 may hold a tissue sample. The system 1000 may further comprise a flow plate assembly 800. The flow plate assembly 800 may comprise a main channel 810. The flow plate assembly 800 may further comprise a main inlet 802 fluidly coupled to the main channel 810, configured to accept air and a solution. The flow plate assembly 800 may further comprise a main outlet 804 fluidly coupled to the main channel 810, configured to direct the air and the solution to a waste reservoir.

The flow plate assembly 800 may further comprise one or more hollow bodies, each hollow body 820 configured to removably contain a cartridge 10 of the one or more cartridges. Each hollow body 820 may comprise an inlet interface 822 fluidly coupled to the first opening 14 of the cartridge 10 and the main channel 810, configured to accept the air and the solution from the main channel 810. Each hollow body 820 may further comprise an outlet interface fluidly coupled to the second opening 16 of the cartridge 10 and the main channel 810, configured to direct the air and the solution from within the cartridge 10 to the main channel 810. Each hollow body 820 may further comprise an inlet valve 826 fluidly coupled to the inlet interface 822, configured to open and close to allow the air and the solution to enter the cartridge 10 through the inlet interface 822. Each hollow body 820 may further comprise an outlet valve 828 fluidly coupled to the outlet interface, configured to open and close to allow the air and the solution to exit the cartridge 10 through the outlet interface.

The flow plate assembly 800 may comprise a main valve 840 disposed in the main channel 810 downstream of the one or more inlet interfaces of the one or more hollow bodies and upstream of the one or more outlet interfaces of the one or more hollow bodies. The system 1000 may further comprise a control mechanism 850 operatively coupled to the one or more inlet valves of the one or more hollow bodies, the one or more outlet valves of the one or more hollow bodies, and the main valve 840, configured to actuate each valve individually. The system 1000 may further comprise a rotating assembly 860 operatively coupled to the flow plate assembly 800, configured to rotate the one or more hollow bodies from an upright position to an inverted position and to rotate the one or more hollow bodies from the inverted position to the upright position.

In some embodiments, the one or more inlet valves, the one or more outlet valves, the main valve 840, or a combination thereof may comprise solenoid valves. In some embodiments, the system 1000 may further comprise a first deflector disposed within the sample chamber 12 relative to the first opening 14. The system 1000 may further comprise a second deflector disposed within the sample chamber 12 relative to the second opening 16. In some embodiments, the first deflector may protect the tissue sample from disruption as a result of the solution entering the sample chamber 12 through the first opening 14. In some embodiments, the second deflector 16 may protect the tissue sample from disruption as a result of the solution exiting the sample chamber 12 through the second opening 16. In some embodiments, at least one of the first and second deflectors may comprise a corrosion-resistant panel.

Referring now to FIG. 9C, the present invention features a method for tissue sample incubation. In some embodiments, the method may comprise providing one or more cartridges. Each cartridge 10 may comprise a sample chamber 12. Each cartridge 10 may further comprise a first opening 14 disposed on a surface of the sample chamber 12. Each cartridge 10 may further comprise a second opening 16 disposed on the surface of the sample chamber 12. Each cartridge 10 may further comprise a solution disposed within the sample chamber 12. Each sample chamber 12 may hold a tissue sample. The method may further comprise providing a flow plate assembly 800 comprising a main channel. The flow plate assembly 800 may further comprise a main inlet 802 fluidly coupled to the main channel. The flow plate assembly 800 may further comprise a main outlet 804 fluidly coupled to the main channel. The flow plate assembly 800 may further comprise one or more hollow bodies. Each hollow body 820 may comprise an inlet interface 822 fluidly coupled to the main channel. Each hollow body 820 may further comprise an outlet interface fluidly coupled to the main channel. Each hollow body 820 may further comprise an inlet valve 826 fluidly coupled to the inlet interface 822. Each hollow body 820 may further comprise an outlet valve 828 fluidly coupled to the outlet interface.

The method may further comprise providing a rotating assembly 860 operatively coupled to the flow plate assembly 800. The method may further comprise inserting the one or more cartridges into the one or more hollow bodies such that the first opening 14 of each cartridge 10 fluidly couples to the inlet interface 822 and the second opening 16 of each cartridge 10 fluidly coupled to the outlet interface. The method may further comprise rotating, by the rotating assembly 860, a cartridge 10 of the one or more cartridges into an inverted position. The method may further comprise actuating the inlet valve 826 and the outlet valve 828 of the hollow body 820 containing the cartridge 10 such that the solution is drained from the cartridge 10 through the second opening 16 into the main channel, and air enters the cartridge 10 through the first port. The method may further comprise directing the solution from the main channel to the main outlet 804.

The method may further comprise rotating, by the rotating assembly 860, the flow plate assembly 800 such that the cartridge 10 is rotated into the upright position. The method may further comprise directing a fresh solution through the main channel. The method may further comprise actuating the inlet valve 826 and the outlet valve 828 of the hollow body 820 containing the cartridge 10 such that the fresh solution enters the cartridge 10 through the first opening 14, and air exits the cartridge 10 through the second opening 16. The method may further comprise directing the air from the main channel to the main outlet 804.

In some embodiments, the one or more inlet valves, the one or more outlet valves, or a combination thereof comprise solenoid valves. In some embodiments, each cartridge 10 may further comprise a first deflector disposed within the sample chamber 12 relative to the first opening 14 and a second deflector disposed within the sample chamber 12 relative to the second opening 16.

In some embodiments, the cartridges may be static within the hollow bodies such that rotating each hollow body 820 causes each cartridge 10 disposed therein to rotate accordingly. This ensures that the first opening 14 of each cartridge 10 aligns with the inlet interface 822 of the hollow body 820 and the second opening 16 of each cartridge 10 aligns with the outlet interface 824 of the hollow body 820 at all times. In some embodiments, the first opening 14 and the second opening 16 of each cartridge 10 may be disposed on the same side of the cartridge 10.

In some embodiments, the control mechanism 850 may be configured to control each valve in the flow plate assembly 800 individually. The control mechanism 850 may actuate the valves at least partially through manual input from a user. The control mechanism 850 may actuate the valves at least partially automatically. For example, the control mechanism 850 may actuate the inlet valve 826 of a hollow body 820 to open it. Then an amount of time after, the control mechanism 850 may actuate the inlet valve 822 again to close it and then open the outlet valve 828. Then an amount of time after, the control mechanism 850 may actuate the outlet valve 828 to close it. If the main channel 810 is to be flushed, the main valve 840 may be actuated by the control mechanism 850 to allow a flushing solution (e.g. saline) through the entirety of the main channel.

In some embodiments, each sample chamber 12 may be filled at least partially with a solution. In some embodiments, each sample chamber 12 may be filled entirely with the solution. In some embodiments, each sample chamber 12 may be filled with the solution just enough to cover the tissue sample 18. In some embodiments, rotation by the rotating assembly 860 may serve to agitate the tissue sample 18.

In some embodiments, the tissue sample 18 may comprise any biological sample. In some embodiments, the solution may comprise water, phosphate-buffered saline, Triton-X100, Tween-20, dimethylsulfoxide, sodium azide, donkey serum, glycine, heparin, methanol, hydrogen peroxide, dichloromethane, dibenzylether, another other solution, or a combination thereof. In some embodiments, a material of the chambers may comprise polypropylene, any other chemical-resistant material, or a combination thereof. In some embodiments, the system of the present invention may comprise one or more components capable of temperature regulation (e.g. heating, cooling). The temperature regulation components may be configured to maintain the cartridges and samples at a temperature of 4 to 37 degrees Celsius.

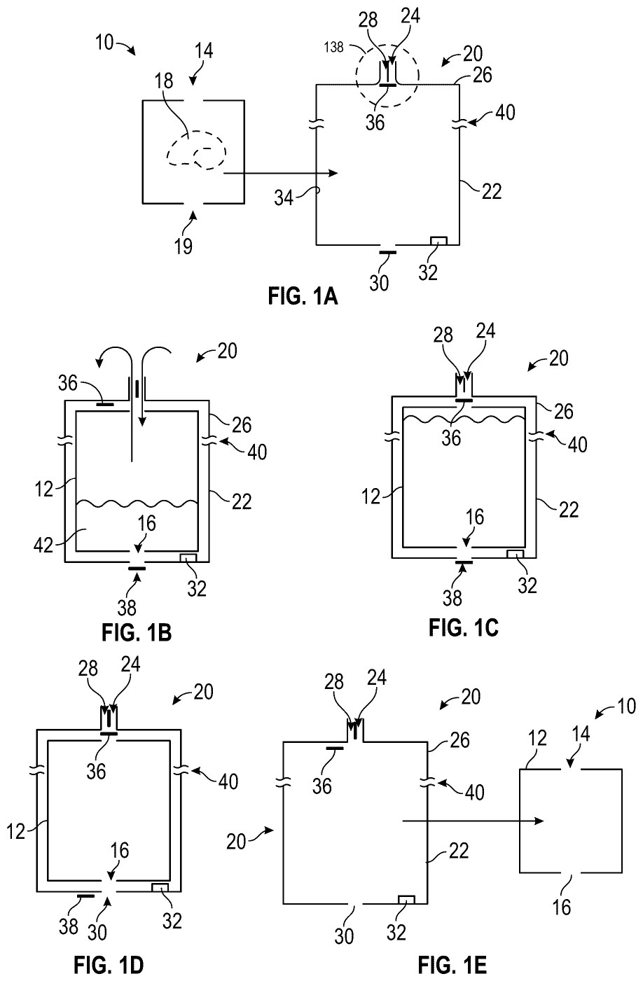

Referring now to FIGS. 1A-1E, the present invention features an automated fluid transfer system for tissue sample incubation. As seen in FIG. 1A, the fluid transfer system may comprise a cartridge 10. The cartridge 10 may comprise a sample chamber 12, a first opening 14 disposed on a surface of the sample chamber 12, and a second opening 16 disposed on the surface of the sample chamber 12. The sample chamber 12 may hold a tissue sample 18, which may comprise a whole brain. As seen in FIG. 1A, the fluid transfer system may further comprise a cartridge holder 20. The cartridge holder 20 may comprise a hollow body 22, an inlet port 24 disposed on a surface 26 of the hollow body 22, an outlet port 28 disposed on the surface 26 of the hollow body 22, a drainage port 30 disposed on the surface 26 of the hollow body 22, a sensor 32 disposed on an inner surface 34 of the hollow body 22, a first closure mechanism 36 disposed over the inlet port 24 and the outlet port 28, and a second closure mechanism 38 disposed over the drainage port 30. The cartridge 10 may be removably disposed within the hollow body 22. The first closure mechanism 36 may be actuated by the sensor 32, and the second closure mechanism 38 may be actuated an amount of time after the first closure mechanism 36 is actuated. Insertion of the cartridge 10 into the hollow body 22 may trigger the sensor 32 and actuate the first closure mechanism 36. Actuating the first closure mechanism 36 may allow a solution 42 from the inlet port 24 to enter the sample chamber 12 through the first opening 24 may allow air from the sample chamber 12 to escape through the first opening 24 and through the outlet port 28, as seen in FIG. 1B. The solution 42 may sit in the sample chamber 12 for an amount of time, as seen in FIG. 1C. Actuating the second closure mechanism 38 may allow the solution 42 to escape through the second opening 16 and through the drainage port 30, as seen in FIG. 1D. The cartridge 10 may then be removed from the cartridge holder 20, as seen in FIG. 1E. In some embodiments, the fluid transfer system further comprises an expansion means 40 acting as a clamp disposed on the inner surface 34 of the hollow chamber 26. The sensor 32 may actuate the expansion means 40 to lock the cartridge 10 in place. The expansion means 40 may utilize hydraulic means, mechanical means, pneumatic means, or combinations of two or more thereof. The sensor 32 may comprise an RF sensor, a mechanical sensor, optical sensor, or combinations of two or more thereof.

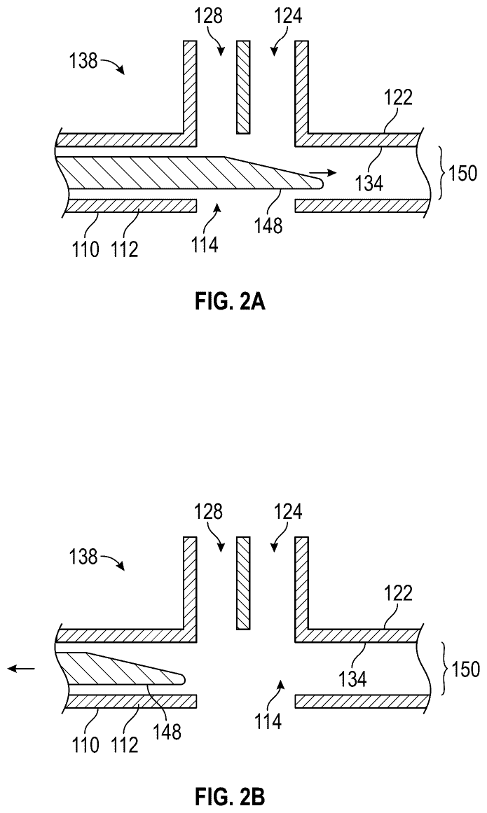

Referring now to FIGS. 2A-2B, which depict a closure subassembly 138, in some embodiments, at least one of the first and second closure mechanisms 138 may comprise a sliding mechanism 148 disposed in a gap 150 between the inner surface 134 of the hollow body 122 and an outer surface 112 of the sample chamber 110. The sliding mechanism 148 may comprise an angled tip to reduce friction, though other configurations, e.g., a blunt tip, a beveled tip, etc. FIG. 2A shows a method of closing the sliding mechanism, and FIG. 2B shows a method of opening the sliding mechanism.

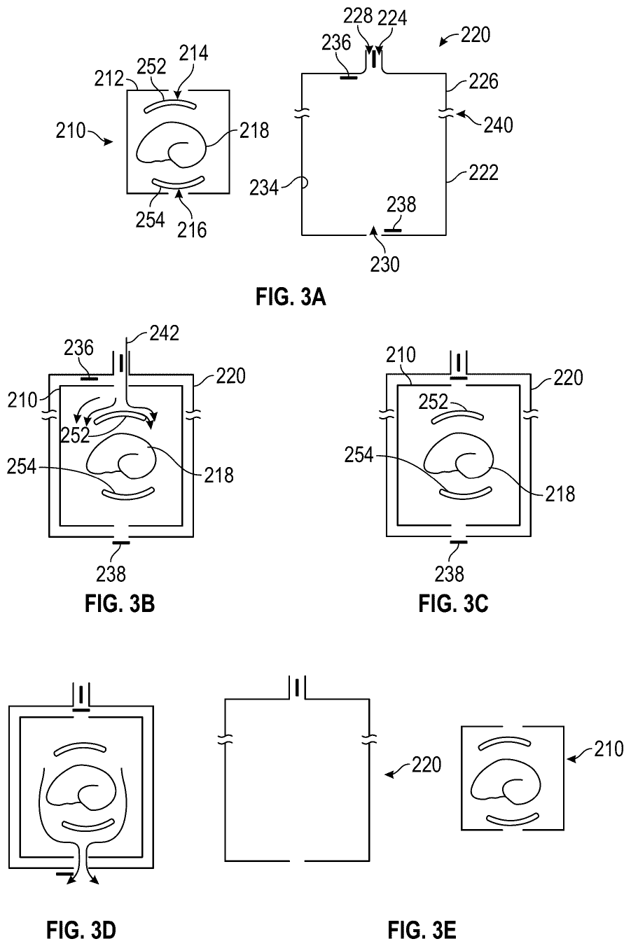

Referring now to FIGS. 3A-3E, which depict a fluid transfer system having one or more deflectors, in some embodiments, the fluid transfer system further comprises a first deflector 252 disposed within the sample chamber 212 proximate to the first opening 214 and a second deflector 254 disposed within the sample chamber 212 proximate to the second opening 216, as seen in FIG. 3A. As further seen in FIG. 3A, the fluid transfer system may further comprise a cartridge holder 220, which may comprise a hollow body 222, an inlet port 224 disposed on a surface 226 of the hollow body 222, an outlet port 228 disposed on the surface 226 of the hollow body 222, a drainage port 230 disposed on the surface 226 of the hollow body 222, a first closure mechanism 236 disposed over the inlet port 224 and the outlet port 228, and a second closure mechanism 238 disposed over the drainage port 230. The cartridge 210 may be removably disposed within the hollow body 222. The first closure mechanism 236 may be actuated, and the second closure mechanism 238 may be actuated an amount of time after the first closure mechanism 236 is actuated. Actuating the first closure mechanism 236 may allow a solution 242 from the inlet port 224 to enter the sample chamber 212 through the first opening 224 may allow air from the sample chamber 212 to escape through the first opening 224 and through the outlet port 228, as seen in FIG. 1B. The first deflector 252 may protect the tissue sample 218 which may comprise, e.g., a whole brain from disruption as a result of the solution 242 entering the sample chamber 212 through the first opening 214, as seen in FIG. 3B. The tissue sample 218 may incubate in the solution 242 for an amount of time, as seen in FIG. 3C. The second deflector 254 may protect the tissue sample 218 from disruption as a result of the solution 242 exiting the sample chamber 212 through the second opening 216, as seen in FIG. 3D. The cartridge 210 containing the tissue sample 218 may be removed from the cartridge holder 220, as seen in FIG. 3E. In some embodiments, at least one of the first and second deflectors 252, 254 may comprise a corrosion-resistant panel or other suitable structure or material.

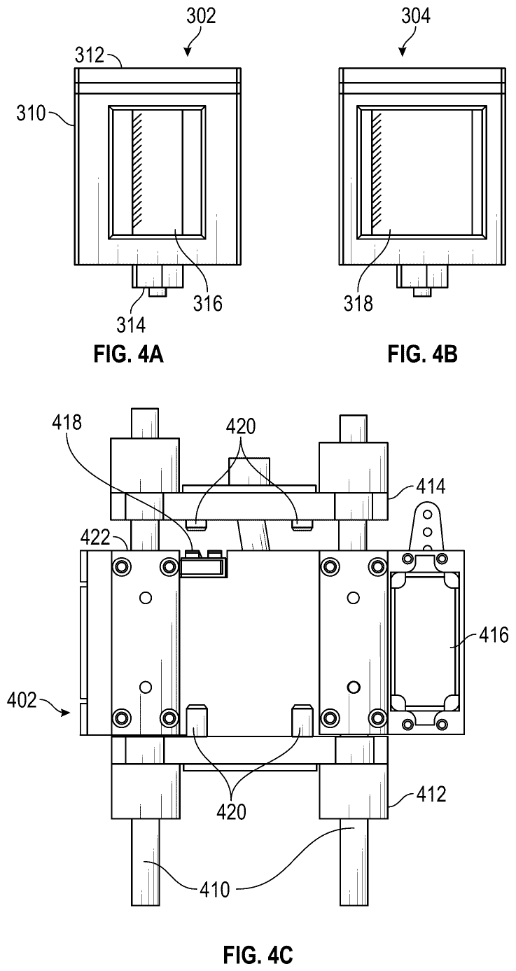

Referring now to FIGS. 4A-4C, the present invention features an alternative embodiment of the fluid transfer system. As seen in FIG. 4A, the fluid transfer system may comprise a tissue chamber 302. Another embodiment of a tissue chamber 304 appears in FIG. 4B. The tissue chamber 302 may comprise a chamber body 310, an inlet valve 312 having a sliding mechanism and allowing for fluid injection, an outlet valve 314 allowing for fluid injection, and a sample chamber 316, 318 comprising a corrosion-resistant tube where a sample may reside. A sample chamber of 5 mL 316 may be used as seen in FIG. 4A. A sample chamber of 20 mL 318 may be used as seen in FIG. 4B. As seen in FIG. 4C, the fluid transfer system may further comprise a fluid exchange station 402. The fluid exchange station 402 may comprise mounting posts 410 upon which the fluid exchange station is mounted, a bottom clamp 412 for securing the tissue chamber and sealing the outlet valve to a vacuum line, a top clamp 414 for securing the tissue chamber and inserting an injection nozzle into the sample chamber, a servo motor 416 for actuating the top and bottom clamps, a limit switch 418 for detecting insertion of the tissue chamber into the fluid exchange station, and a base mount 422 comprising a plurality of registration pins 420 for securing the tissue chamber in place.

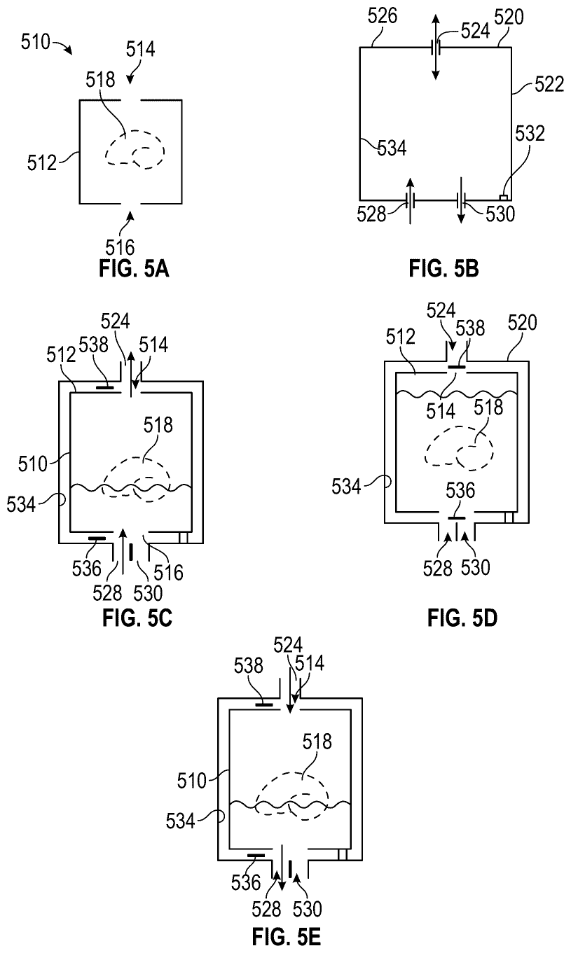

Referring now to FIGS. 5A-5E, the present invention may comprise another embodiment of an automated fluid transfer system for tissue sample incubation. As depicted in FIG. 1A, the fluid transfer system may comprise a cartridge 510. The cartridge 510 may comprise a sample chamber 512, a first opening 514 disposed on a surface of the sample chamber 512, and a second opening 516 disposed on the surface of the sample chamber 512. The sample chamber 512 may hold a tissue sample 518, which may comprise a whole brain. As depicted in FIG. 1B, the fluid transfer system may further comprise a cartridge holder 520. The cartridge holder 520 may comprise a hollow body 522, an air port 524 disposed on a surface 526 of the hollow body 522, a solution inlet port 528 disposed on the surface 526 of the hollow body 522, a solution drainage port 530 disposed on the surface 526 of the hollow body 522, a sensor 532 disposed on an inner surface 534 of the hollow body 522, a first closure mechanism 536 movably disposed over the inlet port 528 and the drainage port 530, and a second closure mechanism 538 movably disposed over first opening 514. The cartridge 510 may be removably disposed within the hollow body 522, as depicted in FIG. 5C. A solution may be introduced through solution inlet port 528 as air escapes through air port 524. The solution may be held within the cartridge 510 by back pressure from solution outlet port 530, or, in some embodiments, by closure or partial closure of the closure mechanism 538. In some embodiments, the first closure mechanism 536 may be actuated by the sensor 532 to introduce solution through solution inlet port 528 and the second closure mechanism 538 may be actuated by the sensor 532 to permit efflux of air through air port 524. Once the cartridge 510 is filled sufficiently to cover the tissue sample 518, as depicted in FIG. 5D, the first closure mechanism 536 may be actuated to close the solution inlet port 528 and the solution outlet port 530, and the second closure mechanism 538 may be actuated to close the air port 524, thereby maintaining the solution within the cartridge 510 for a period of time, e.g., for a period long enough to clear the tissue sample 518. As depicted in FIG. 5E, after a period of time, e.g., a period sufficient to clear the tissue sample 518, the first closure mechanism 536 may be actuated to allow solution to escape the cartridge 510 through solution outlet port 530 and the second closure mechanism 538 may be actuated to allow air to enter the cartridge 510 through the air port 524.

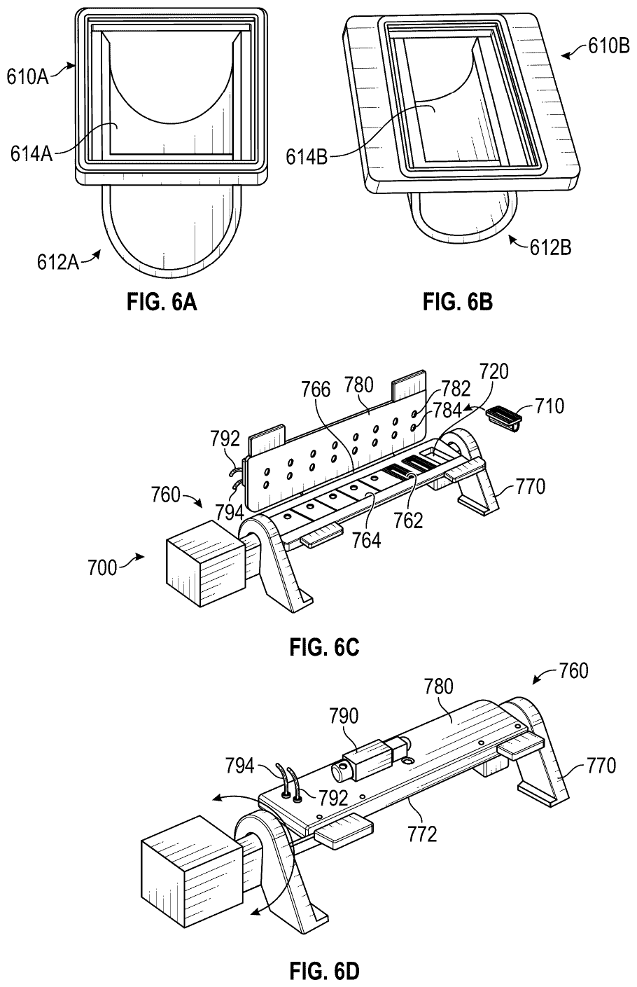

An additional embodiment of a cartridge 610A is depicted in FIG. 6A. The cartridge, 610A comprises a cartridge wall 612A, which may be a semi-cylinder or other appropriate shape. The cartridge 610A includes an opening 614A adapted for introduction of a tissue sample and solution. The cartridge 610A may have a first volume, which may be sized to receive a whole rat brain, a partial rat brain, a whole mouse brain, a partial mouse brain, etc.

Another embodiment of a cartridge 610B is depicted in FIG. 6B. The cartridge, 610B comprises a cartridge wall 612B, which may be a semi-cylinder or other appropriate shape. The cartridge 610B includes an opening 614B adapted for introduction of a tissue sample and solution. The cartridge 610B may have a volume, which may be sized to receive a whole rat brain, a partial rat brain, a whole mouse brain, a partial mouse brain, etc. The volume of the cartridge 610B may be different from the volume of the cartridge 610B.

Each cartridge 610A, 610B may be of a suitable volume, e.g., 4 mL for a half mouse brain or partial rat brain, 6 mL for a whole mouse brain, or 40 mL for a whole rat brain. A tissue sample may be placed in the cartridge 610A, 610B along with saline or other solution.

An additional embodiment of a clearing system 700 is shown in FIGS. 6C-6D. The clearing system 700 comprises one or more cartridges 710 and an automated clearing station 760, which comprises a base 770 comprising one or more cartridge holders 720 adapted to receive the one or more cartridges 710. The clearing station 760 further comprises a movable lid 780, which may be rotatably e.g., about one or more hinges 766 coupled to the base 770. The system 700 may also comprise one or more blanks 764, which may be placed in one or more cartridge holders 720 when not in use. The movable lid may comprise a solution inlet 792 for influx of solution, and solution outlet 794 for efflux of solution, during operation of the clearing system 700. Solution may be circulated through the one or more cartridges 710 through one or more inlets 782 and outlets 784 in the lid 780. As shown by the rotation arrow, the movable lid 780 may be closed e.g., by rotating the lid 780 about one or more hinges 766 to form a rotatable sub-assembly 772, as depicted in FIG. 6D.

As depicted in FIG. 6D, once the lid 780 is closed, a pump assembly 790 may pump solution from an external source not shown into the clearing station 760 through solution inlet 792 in the lid 780 and out through solution outlet 794 to a waste receptacle for disposal or recycling. Operation of the pump assembly 790 may be automated. The rotatable subassembly 772 may be rotated, e.g., up to 360°, as indicated by the rotation arrows, to assist in mixing and accelerate clearing. Such rotation may be cyclical, in either or both directions, and may be automated.

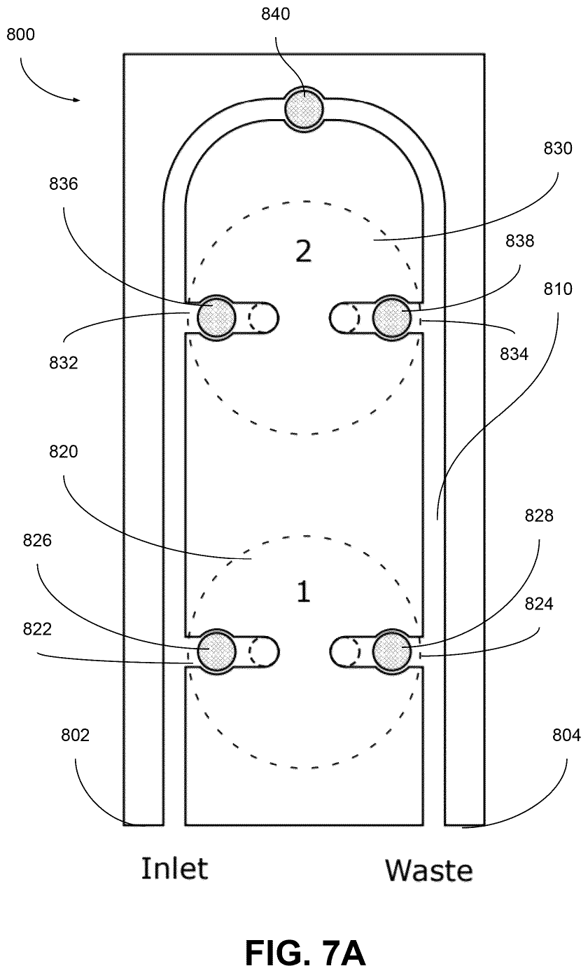

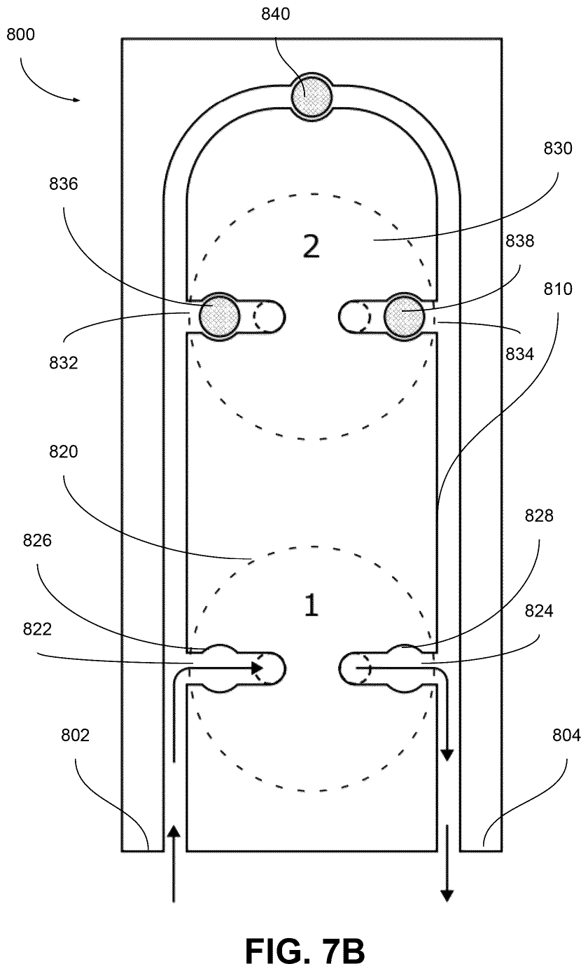

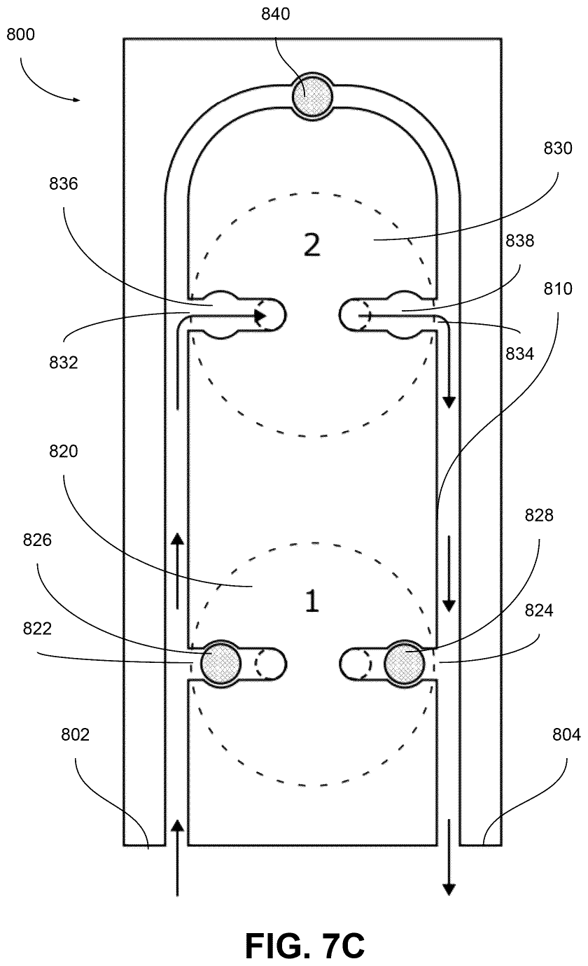

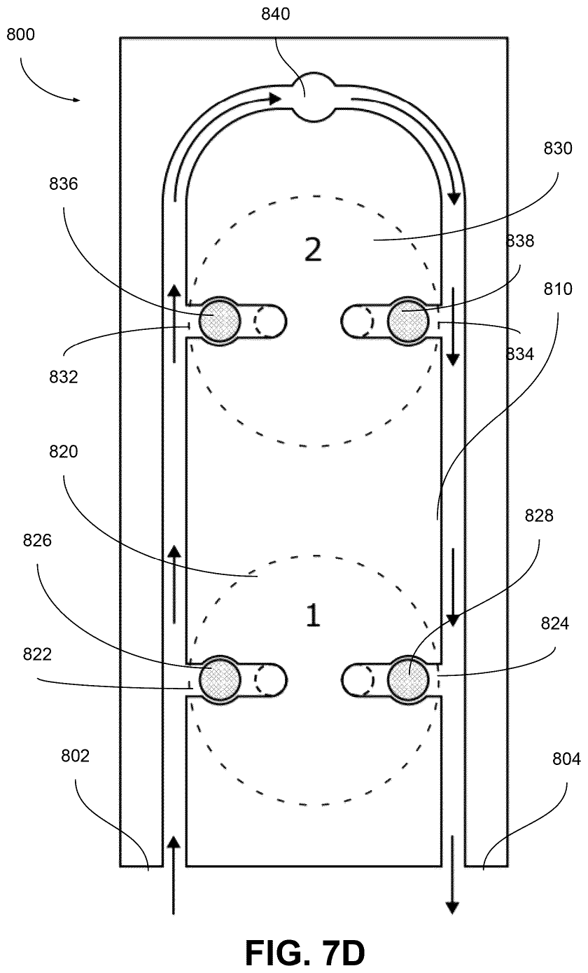

As depicted in FIGS. 7A-7D, the present invention features a flow plate assembly 800. One main channel 810 runs from the main inlet 802 to the outlet 804, passing adjacent to each chamber 820, 830 twice. Each chamber 820, 830 has an inlet 822, 832 that is connected to the “upstream” path of the main channel 810, and an outlet 824, 834 that is connected to the “downstream” path of the main channel 810. A first solenoid valve 826 sits at the inlet interface 822 and a second solenoid valve 828 sits at the outlet interface 824 of the first chamber 820. A third solenoid valve 836 sits at the inlet interface 832 and a fourth solenoid valve 838 sits at the outlet 834 interface of the second chamber 830. A fifth solenoid 840 also sits at the midpoint of the main channel 810. The advantage of this configuration is that each chamber 820, 830 can be individually addressed, rather than being required to distribute the solution evenly to all chambers simultaneously. To target a specific chamber, the inlet and outlet valves for the target chamber are opened and fluid is pumped into the main channel 810. It will travel down the path of least resistance through the open inlet path, into the chamber, and then out the outlet. This design supports an arbitrary number of chambers and can be expanded by simply adding new chamber/channel interfaces.

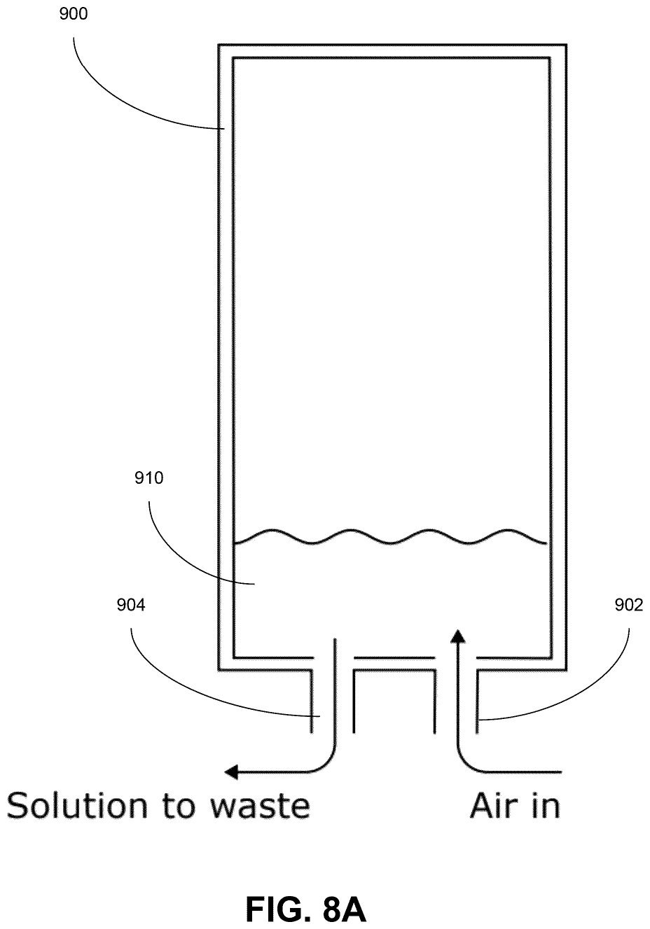

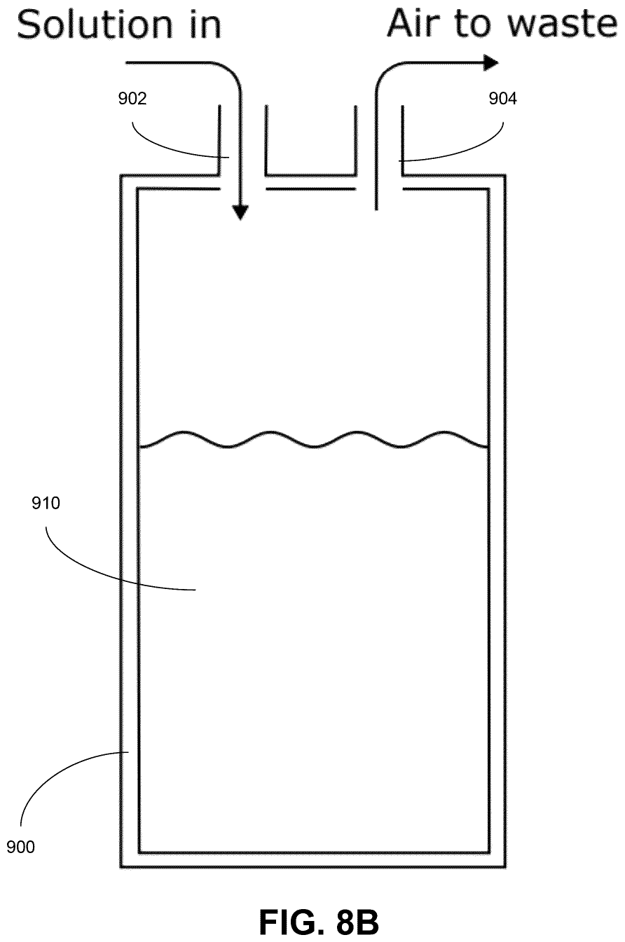

FIGS. 8A-8B show the solution exchange cycle of the present invention. The first phase is the drain phase. Chambers are inverted and air is pumped in. As air enters the chamber 900 through the inlet 902, it accumulates and creates a pressure differential that drives the existing solution 910 in the chamber 900 through the outlet 904, where it travels through the main channel towards waste. In the fill phase, the chamber 900 is returned to the upright orientation and solution 910 is pumped in through the inlet 902. As solution 910 fills the chamber 900, air is expelled through the outlet 904 and towards the waste. Note that whether filling or draining, the direction of fluid travel through the system is always in the same direction.

Although there has been shown and described preferred embodiments of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A solution transfer system 1000 for tissue sample incubation comprising:
a. one or more cartridges, each cartridge 10 comprising:
i. a sample chamber 12,
ii. a first opening 14 disposed on a surface of the sample chamber 12, and
iii. a second opening 16 disposed on the surface of the sample chamber 12,
wherein the sample chamber 12 holds a tissue sample,
b. a flow plate assembly 800 comprising:
i. a main channel 810,
ii. a main inlet 802 fluidly coupled to the main channel 810,
iii. a main outlet 804 fluidly coupled to the main channel 810,
iv. one or more hollow bodies, each hollow body 820 configured to removably contain a cartridge 10 of the one or more cartridges, each hollow body 820 comprising:
A. an inlet interface 822 fluidly coupled to the first opening 14 of the cartridge 10 and the main channel 810,
B. an outlet interface 824 fluidly coupled to the second opening 16 of the cartridge 10 and the main channel 810,
C. an inlet valve 826 fluidly coupled to the inlet interface 822, and
D. an outlet valve 828 fluidly coupled to the outlet interface, and
v. a main valve 840 disposed in the main channel 810 downstream of the one or more inlet interfaces of the one or more hollow bodies and upstream of the one or more outlet interfaces of the one or more hollow bodies, and
c. a control mechanism 850 operatively coupled to the one or more inlet valves of the one or more hollow bodies, the one or more outlet valves of the one or more hollow bodies, and the main valve 840, configured to actuate each valve individually.

2. The system 1000 of claim 1, wherein the one or more inlet valves, the one or more outlet valves, the main valve 840, or a combination thereof comprise solenoid valves.

3. The system 1000 of claim 1 further comprising a rotating assembly 860 operatively coupled to the flow plate assembly 800, configured to rotate the one or more hollow bodies from an upright position to an inverted position and to rotate the one or more hollow bodies from the inverted position to the upright position.

4. The system 1000 of claim 3, wherein each cartridge 10 of the one or more cartridges is configured to contain a solution.

5. A method for flushing a cartridge 10 of the one or more cartridges of the system 1000 of claim 4, the method comprising:
a. rotating the flow plate assembly 800 such that the cartridge 10 is rotated into the inverted position,
b. actuating the inlet valve 826 and the outlet valve 828 of the hollow body 820 containing the cartridge 10 such that the solution is drained from the cartridge 10 through the second opening 16 into the main channel 810, and air enters the cartridge 10 through the first port, and
c. directing the solution from the main channel 810 to the main outlet 804.

6. A method for filling a cartridge 10 of the one or more cartridges of the system 1000 of claim 4, the method comprising:
a. rotating the flow plate assembly 800 such that the cartridge 10 is rotated into the upright position,
b. directing the solution through the main channel 810,
c. actuating the inlet valve 826 and the outlet valve 828 of the hollow body 820 containing the cartridge 10 such that the solution enters the cartridge 10 through the first opening 14, and air exits the cartridge 10 through the second opening 16, and
d. directing the air from the main channel 810 to the main outlet 804.

7. The system 1000 of claim 1 further comprising:
a. a first deflector disposed within the sample chamber 12 relative to the first opening 14, and
b. a second deflector disposed within the sample chamber 12 relative to the second opening 16.

8. The system 1000 of claim 7, wherein the first deflector protects the tissue sample from disruption as a result of the solution entering the sample chamber 12 through the first opening 14.

9. The system 1000 of claim 7, wherein the second deflector protects the tissue sample from disruption as a result of the solution exiting the sample chamber 12 through the second opening 16.

10. The system 1000 of claim 7, wherein at least one of the first and second deflectors comprise a corrosion-resistant panel.

11. A solution transfer system 1000 for tissue sample incubation comprising:
a. one or more cartridges, each cartridge 10 comprising:
i. a sample chamber 12,
ii. a first opening 14 disposed on a surface of the sample chamber 12, and
iii. a second opening 16 disposed on the surface of the sample chamber 12,
wherein the sample chamber 12 holds a tissue sample,
b. a flow plate assembly 800 comprising:
i. a main channel 810,
ii. a main inlet 802 fluidly coupled to the main channel 810, configured to accept air and a solution,
iii. a main outlet 804 fluidly coupled to the main channel 810, configured to direct the air and the solution to a waste reservoir,
iv. one or more hollow bodies, each hollow body 820 configured to removably contain a cartridge 10 of the one or more cartridges, each hollow body 820 comprising:
A. an inlet interface 822 fluidly coupled to the first opening 14 of the cartridge 10 and the main channel 810, configured to accept the air and the solution from the main channel 810,
B. an outlet interface fluidly coupled to the second opening 16 of the cartridge 10 and the main channel 810, configured to direct the air and the solution from within the cartridge 10 to the main channel 810,
C. an inlet valve 826 fluidly coupled to the inlet interface 822, configured to open and close to allow the air and the solution to enter the cartridge 10 through the inlet interface 822, and
D. an outlet valve 828 fluidly coupled to the outlet interface, configured to open and close to allow the air and the solution to exit the cartridge 10 through the outlet interface, and
v. a main valve 840 disposed in the main channel 810 downstream of the one or more inlet interfaces of the one or more hollow bodies and upstream of the one or more outlet interfaces of the one or more hollow bodies,
c. a control mechanism 850 operatively coupled to the one or more inlet valves of the one or more hollow bodies, the one or more outlet valves of the one or more hollow bodies, and the main valve 840, configured to actuate each valve individually, and
d. a rotating assembly 860 operatively coupled to the flow plate assembly 800, configured to rotate the one or more hollow bodies from an upright position to an inverted position and to rotate the one or more hollow bodies from the inverted position to the upright position.

12. The system 1000 of claim 11, wherein the one or more inlet valves, the one or more outlet valves, the main valve 840, or a combination thereof comprise solenoid valves.

13. The system 1000 of claim 11 further comprising:
a. a first deflector disposed within the sample chamber 12 relative to the first opening 14, and
b. a second deflector disposed within the sample chamber 12 relative to the second opening 16.

14. The system 1000 of claim 13, wherein the first deflector protects the tissue sample from disruption as a result of the solution entering the sample chamber 12 through the first opening 14.

15. The system 1000 of claim 13, wherein the second deflector 16 protects the tissue sample from disruption as a result of the solution exiting the sample chamber 12 through the second opening 16.

16. The system 1000 of claim 13, wherein at least one of the first and second deflectors comprise a corrosion-resistant panel.

17. A method for tissue sample incubation comprising:
a. providing one or more cartridges, each cartridge 10 comprising:
i. a sample chamber 12,
ii. a first opening 14 disposed on a surface of the sample chamber 12,
iii. a second opening 16 disposed on the surface of the sample chamber 12, and
iv. a solution disposed within the sample chamber 12,
wherein each sample chamber 12 holds a tissue sample, and
b. providing a flow plate assembly 800 comprising:
i. a main channel 810,
ii. a main inlet 802 fluidly coupled to the main channel,
iii. a main outlet 804 fluidly coupled to the main channel, and
iv. one or more hollow bodies, each hollow body 820 comprising:
A. an inlet interface 822 fluidly coupled to the main channel,
B. an outlet interface fluidly coupled to the main channel,
C. an inlet valve 826 fluidly coupled to the inlet interface 822, and
D. an outlet valve 828 fluidly coupled to the outlet interface,
c. providing a rotating assembly 860 operatively coupled to the flow plate assembly 800,
d. inserting the one or more cartridges into the one or more hollow bodies such that the first opening 14 of each cartridge 10 fluidly couples to the inlet interface 822 and the second opening 16 of each cartridge 10 fluidly coupled to the outlet interface,
e. rotating, by the rotating assembly 860, a cartridge 10 of the one or more cartridges into an inverted position,
f. actuating the inlet valve 826 and the outlet valve 828 of the hollow body 820 containing the cartridge 10 such that the solution is drained from the cartridge 10 through the second opening 16 into the main channel, and air enters the cartridge 10 through the first port,
g. directing the solution from the main channel to the main outlet 804,
h. rotating, by the rotating assembly 860, the flow plate assembly 800 such that the cartridge 10 is rotated into the upright position,
i. directing a fresh solution through the main channel 810,
j. actuating the inlet valve 826 and the outlet valve 828 of the hollow body 820 containing the cartridge 10 such that the fresh solution enters the cartridge 10 through the first opening 14, and air exits the cartridge 10 through the second opening 16, and
k. directing the air from the main channel to the main outlet 804.

18. The method of claim 17, wherein the one or more inlet valves, the one or more outlet valves, or a combination thereof comprise solenoid valves.

19. The method of claim 17, wherein each cartridge 10 further comprises:
a. a first deflector disposed within the sample chamber 12 relative to the first opening 14, and
b. a second deflector disposed within the sample chamber 12 relative to the second opening 16.
